(19) United States
(12) Patent Application Publication
(10) Pub. No.: US 2011/0163999 A1
(43) Pub. Date: Jul. 7, 2011

(54) DISPLAY DEVICE AND TOUCH CONTROL DEVICE THEREOF

(75) Inventor: Yen Chih Lin, Taipei County (TW)

(73) Assignee: AmTRAN TECHNOLOGY CO., LTD, Taipei County (TW)

(21) Appl. No.: 12/720,256

(22) Filed: Mar. 9, 2010

(30) Foreign Application Priority Data
Jan. 6, 2010 (TW) 099200189

(51) Int. Cl. G06F 3/042; H01H 9/00

(52) U.S. Cl. 345/176; 200/512; 200/310

(57) ABSTRACT

A touch control device includes a bracket, a first circuit board and a second circuit board electrically connected to each other, and a light guiding sheet. The first circuit board is disposed on the bracket, and the first circuit board has at least one light emitting element. The second circuit board is a flexible printed circuit (FPC), and has at least one trigger region aligned with the light emitting element. The light guiding sheet is attached to the second circuit board, for guiding light emitted by the light emitting element. The touch control device is disposed on a display device having a curve shape through the flexible second circuit board.

### CROSS-REFERENCE TO RELATED APPLICATIONS

This non-provisional application claims priority under 35 U.S.C. §119(a) on Patent Application No(s). 099200189 filed in Taiwan, R.O.C. on Jan. 6, 2010, the entire contents of which are hereby incorporated by reference.

### BACKGROUND OF THE INVENTION

1. Field of the Invention

The present invention relates to a display device, and more particularly to a display device having a touch control device having a curve shape.

2. Related Art

Since the launch of display devices, users can view the fanciest things all over the world at home for entertainment and knowledge. As the electronic industry is highly developed, the display devices have evolved from early cathode ray tubes (CRTs) to currently most popular thin displays such as liquid crystal displays (LCDs) and plasma display panels (PDPs). Meanwhile, as compared with the CRTs, the thin displays are characterized by light weight, thin structure, and high-quality image display effect, and thus are widely applied to computers or various video devices.

Further, at least one capsense sensor is arranged on the thin display to replace conventional buttons or knobs, thereby making the appearance of the thin display smoother. The capsense sensor generally manipulates the thin display in a capacitive sensing touch control manner, that is, when a finger of the user approaches or touches the capsense sensor, the capsense sensor produces a capacitance effect and causes a change in capacitance, thereby enabling the thin display to execute a control action.

In addition, in order to meet the increasing requirements of consumers on the appearance of the thin display, manufacturers begin to design the frame body of the thin display to present a curved appearance, such that the appearance is no longer an invariable shape, but has a fashionable design.

However, if the frame body of the thin display is designed to present various non-planar appearances, serious problems are encountered with respect to the capsense sensor. That is, the circuit board of the conventional capsense sensor mostly adopts a rigid glass fiber (FR4) board, and limited by the characteristics of the material, the circuit board cannot be sharply bent according to the curve shape of the frame body of the thin display, so that an outer cover (covering) in front of the trigger region on the circuit board is thickened, and the thickness is non-uniform. As a result, the trigger sensitivity is greatly attenuated, the reliability is lowered, and even triggering cannot be achieved.

### SUMMARY OF THE INVENTION

In view of the above problems, the present invention is a display device and a touch control device thereof, so as to solve the problems that the circuit board of the conventional capsense sensor cannot be bent due to the material characteristics, and thus is not applicable to the frame body of the thin display having the curve shape, and that in order to conform to the appearance of the frame body of the thin display, the outer cover (covering) in front of the trigger region on the circuit board is thickened, and the thickness is non-uniform, resulting in poor trigger sensitivity.

The present invention provides a touch control device, which comprises a bracket, a first circuit board, a second circuit board, and a light guiding sheet. The first circuit board is disposed on the bracket, and has at least one light emitting element. The second circuit board is a flexible printed circuit (FPC), is electrically connected to the first circuit board, and has at least one trigger region opposite to the light emitting element. The light guiding sheet is attached to the second circuit board, for guiding light emitted by the light emitting element.

The touch control device of the present invention further comprises a panel, disposed on the bracket and attached to the light guiding sheet. The panel has at least one display pattern, and displays the display pattern using the light emitted by the light emitting element.

The present invention further provides a display device, which comprises a frame body and a touch control device disposed on the frame body. The touch control device comprises a bracket, a first circuit board, a second circuit board, and a light guiding sheet. The first circuit board is disposed on the bracket, and has at least one light emitting element. The second circuit board is an FPC, is electrically connected to the first circuit board, and has at least one trigger region opposite to the light emitting element. The light guiding sheet is attached to the second circuit board, for guiding light emitted by the light emitting element.

The effect of the present invention lies in that, the trigger regions are electrically disposed on the flexible second circuit board, the light emitting elements and other electronic components are electrically disposed on the first circuit board, and the second circuit board may be bent to various non-planar geometrical shapes, such that the touch control device of the present invention is applicable to a display device having a curve-shaped appearance, and the touch control device still has good trigger sensitivity.

### BRIEF DESCRIPTION OF THE DRAWINGS

The present invention will become more fully understood from the detailed description given herein below for illustration only, and thus are not limitative of the present invention, and wherein:

FIG. 1A is an exploded view of a touch control device according to a first embodiment of the present invention;

FIG. 1B is an exploded view of the touch control device according to the first embodiment of the present invention;

FIG. 2A is a schematic three-dimensional view of the touch control device according to the first embodiment of the present invention;

FIG. 2B is a schematic three-dimensional view of the touch control device according to the first embodiment of the present invention;

FIG. 3A is an exploded view of a touch control device according to a second embodiment of the present invention;

FIG. 3B is an exploded view of the touch control device according to the second embodiment of the present invention;

FIG. 4A is a schematic three-dimensional view of the touch control device according to the second embodiment of the present invention;

FIG. 4B is a schematic three-dimensional view of the touch control device according to the second embodiment of the present invention;

FIG. 5A is an exploded view of a display device having the touch control device according to the first embodiment of the present invention disposed therein;

FIG. 5B is a schematic three-dimensional view of the display device having the touch control device according to the first embodiment of the present invention disposed therein;

FIG. 6A is an exploded view of a display device having the touch control device according to the second embodiment of the present invention disposed therein; and

FIG. 6B is a schematic three-dimensional view of the display device having the touch control device according to the second embodiment of the present invention disposed therein.

### DETAILED DESCRIPTION OF THE INVENTION

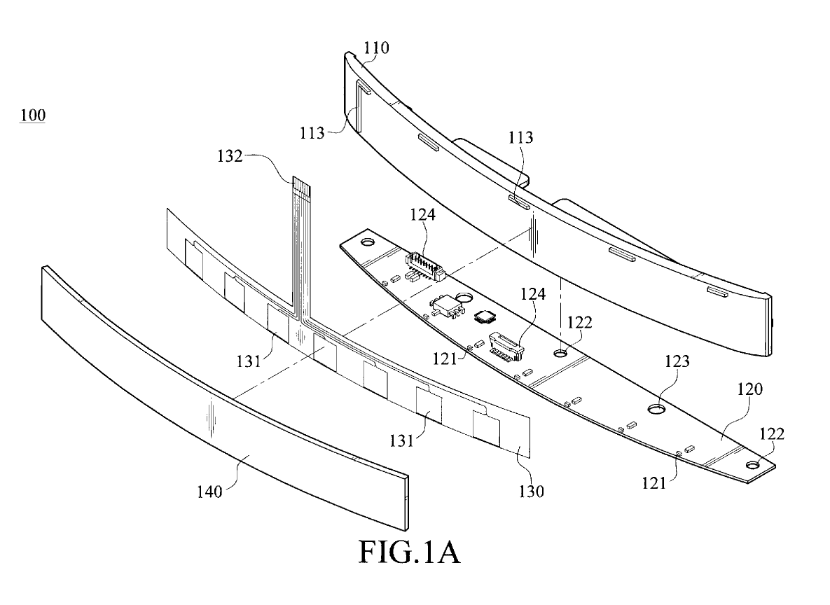

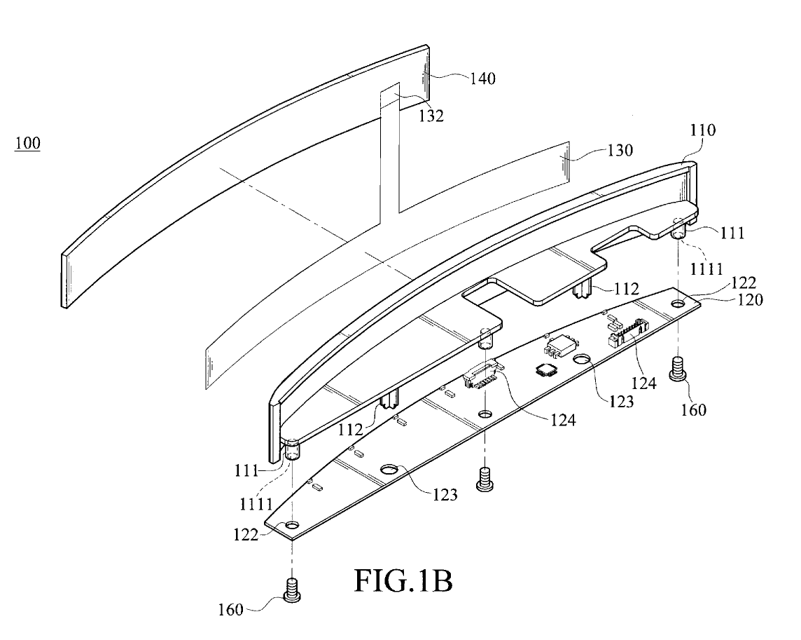

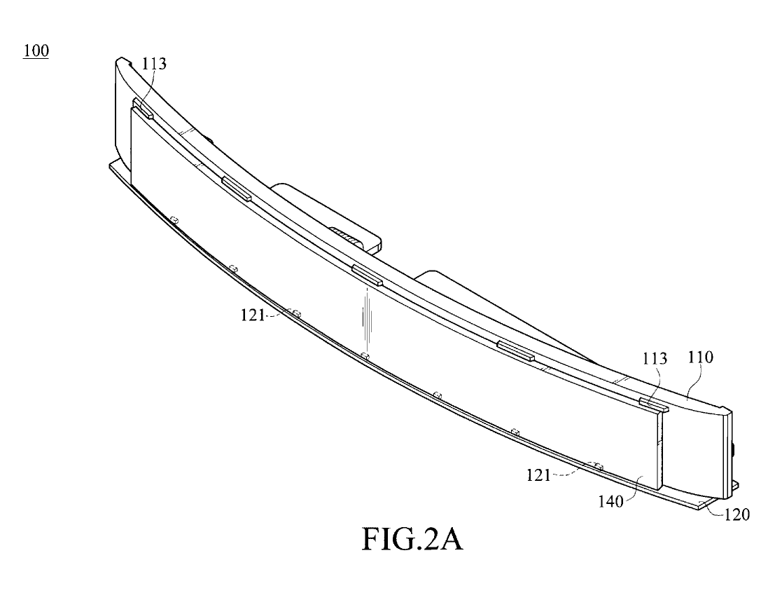

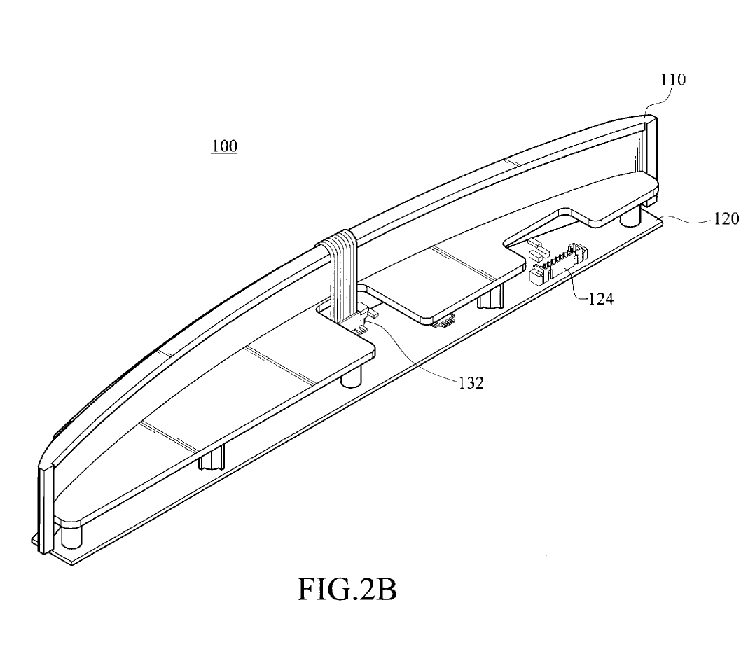

FIGS. 1A to 2B are exploded views and schematic three-dimensional views according to a first embodiment of the present invention.

A touch control device 100 according to the first embodiment of the present invention comprises a bracket 110, a first circuit board 120, a second circuit board 130, and a light guiding sheet 140. The bracket 110 is a curved, arc-shaped bracket, and has a plurality of fixing posts 111 and a plurality of positioning posts 112 extending from one side surface thereof. A combination hole 1111 is disposed on one end of each fixing post 111, and the fixing posts 111 and the positioning posts 112 are alternately arranged. The first circuit board 120 is a printed circuit board (PCB), for example, an FR4 circuit board or other rigid circuit boards. A side edge of the first circuit board 120 is an arc-shaped edge, and a plurality of light emitting elements 121 being spaced apart are electrically disposed at positions on an upper surface of the first circuit board 120 near the arc-shaped edge. A plurality of through holes 122 and a plurality of positioning holes 123 are respectively opened on the first circuit board 120 corresponding to the fixing posts 111 and the positioning posts 112, and the positioning posts 112 are inserted in the positioning holes 123, such that the first circuit board 120 is retained on the bracket 110. Further, combination members 160, for example, screws or pins, pass through the through holes 122 and are disposed in the combination holes 1111 of the fixing posts 111, such that the first circuit board 120 is fixed on the bracket 110 without falling off. In addition, two electrical connection ports 124 are further electrically disposed on the upper surface of the first circuit board 120.

It should be noted that, the numbers of the fixing posts 111 and the positioning posts 112 of the bracket 110 are not limited to the numbers disclosed in this embodiment, and accordingly, the numbers of the through holes 122 and the positioning holes 123 of the first circuit board 120 are not limited to the numbers disclosed in this embodiment; meanwhile, the number of the light emitting elements 121 disposed on the first circuit board 120 is not limited, and the number and positions thereof may be adjusted according to the actual design requirements. The light emitting elements 121 of this embodiment are light emitting diodes (LEDs), and may be side-emitting LEDs or top-emitting LEDs; however, persons skilled in the art may select the most appropriate type of the light emitting elements 121 according to the actual design requirements, and the present invention is not limited to this embodiment.

Referring to FIGS. 1A to 2B, the second circuit board 130 of the present invention is an FPC, and the material of the FPC comprises a polyimide (PI) film and a polyester (PET) film. The second circuit board 130 is erected on the upper surface of the first circuit board 120, and is attached to a curved surface of the bracket 110. The second circuit board 130 is disposed along the arc-shaped edge of the first circuit board 120, and is neighboring to the light emitting elements 121 on the first circuit board 120, such that the second circuit board 130 is corresponding to the curve shape of the arc-shaped edge of the first circuit board 120. A plurality of trigger regions 131 being spaced apart is disposed on a side surface of the second circuit board 130. When the second circuit board 130 is erected on the first circuit board 120, each trigger region 131 is respectively opposite to each light emitting element 121.

In addition, the second circuit board 130 further has a first electrical connector 132 electrically connected to the circuit of each trigger region 131, and the first electrical connector 132 is electrically connected to one of the electrical connection ports 124 on the first circuit board 120, such that the first circuit board 120 is electrically connected to the second circuit board 130.

Referring to FIGS. 1A to 2B, the light guiding sheet 140 of the present invention is made of a light transmissive rubber material, the light guiding sheet 140 is attached to a side surface of the second circuit board 130 by a non-electrically-conductive adhesive, and the light guiding sheet 140 and the second circuit board 130 are attached to the curved surface of the bracket 110 at the same time, such that the second circuit board 130 is stably sandwiched between the bracket 110 and the light guiding sheet 140, so as to prevent the second circuit board 130 from displacement under the action of an external force.

The bracket 110 of this embodiment further has a plurality of positioning ribs 113 protruding from the curved surface thereof, and the positioning ribs 113 define a scope matching the size of the light guiding sheet 140, such that when the light guiding sheet 140 is attached to the bracket 110, a quick and accurate alignment may be performed, thereby accurately aligning the trigger regions 131 of the second circuit board 130 with the light emitting elements 121. In this manner, light emitted by the light emitting element 121 may be uniformly scattered after being guided by the light guiding sheet 140.

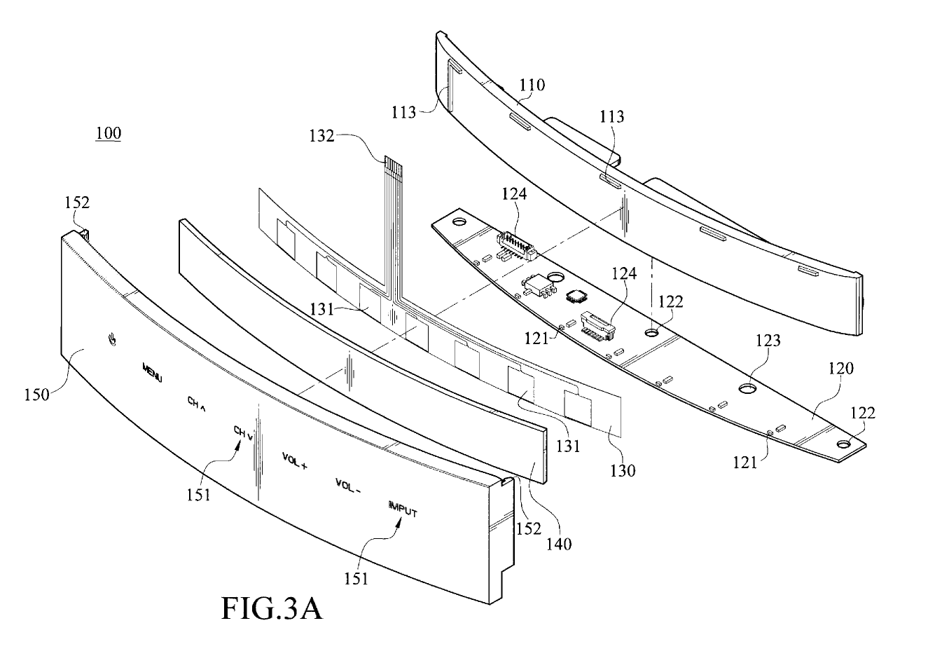

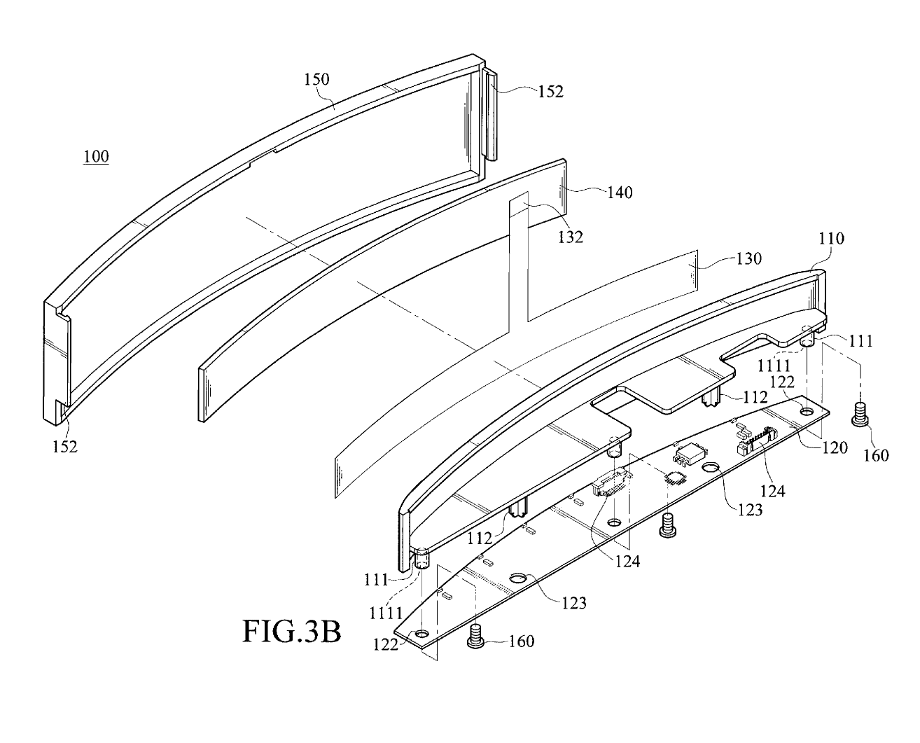

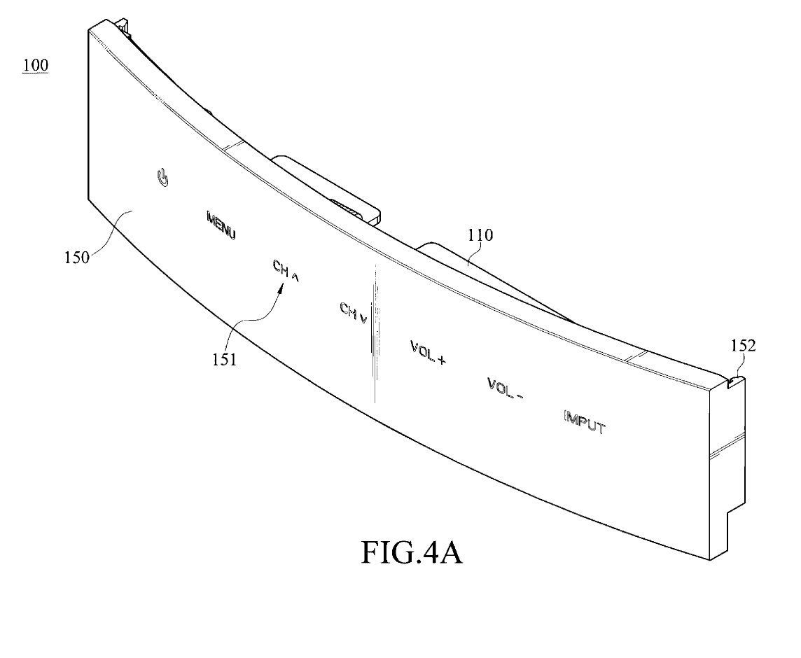

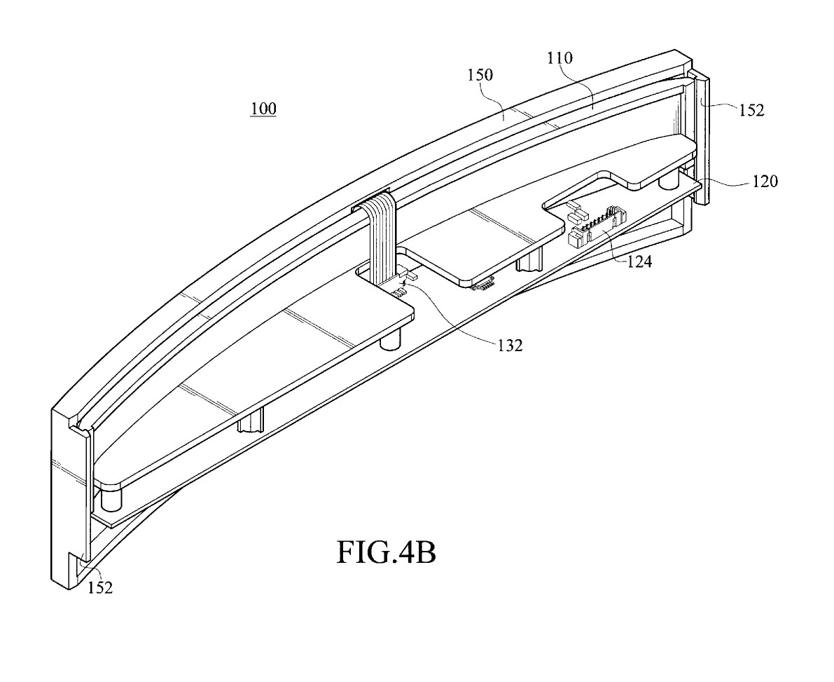

FIGS. 3A to 4B are exploded views and schematic three-dimensional views of a touch control device according to a second embodiment of the present invention.

The second embodiment of the present invention is approximately the same as the first embodiment, except that in the second embodiment, the panel 150 is further closely attached to the light guiding sheet 140 by the non-electrically-conductive adhesive. Further, the panel 150 has a plurality of display patterns 151, for example, a power supply icon, a channel switching icon, and a volume adjusting icon, each display pattern 151 is respectively corresponding to each trigger region 131 of the second circuit board 130, and the light emitted by the light emitting element 121 is uniformly scatted by the light guiding sheet 140, such that the display patterns of the panel 150 are clearly displayed, thereby allowing the user to correctly recognize functions represented by the display patterns 151, and thus correctly execute manipulation instructions. Further, two opposite side edges of the panel 150 respectively have a buckling element 152, for example, a buckle piece, and each buckling element 152 respectively has a hook portion, for hooking the panel 150 to the bracket 110.

The buckling element 152 of this embodiment is in the form of a buckle piece integrally extending from the two side edges of the panel 150, and is hooked to the bracket 110 to form a fixed connection there-between. However, persons skilled in the art may also adopt various types of fixing elements, for example, screws, pins, and bolts, as long as a holding relationship between the panel 150 and the bracket 110 is provided, and the present invention is not limited to this embodiment.

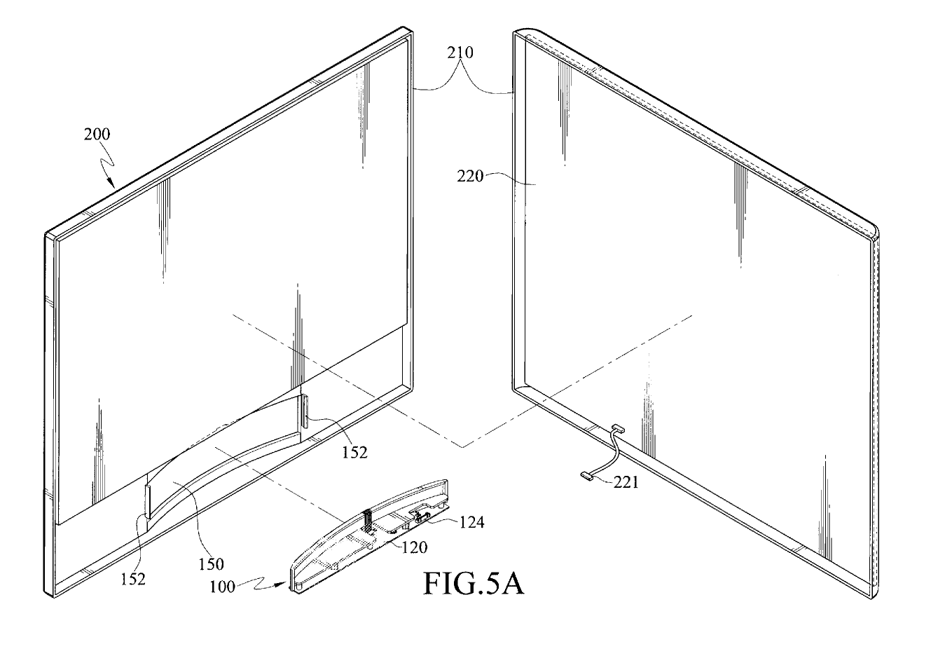

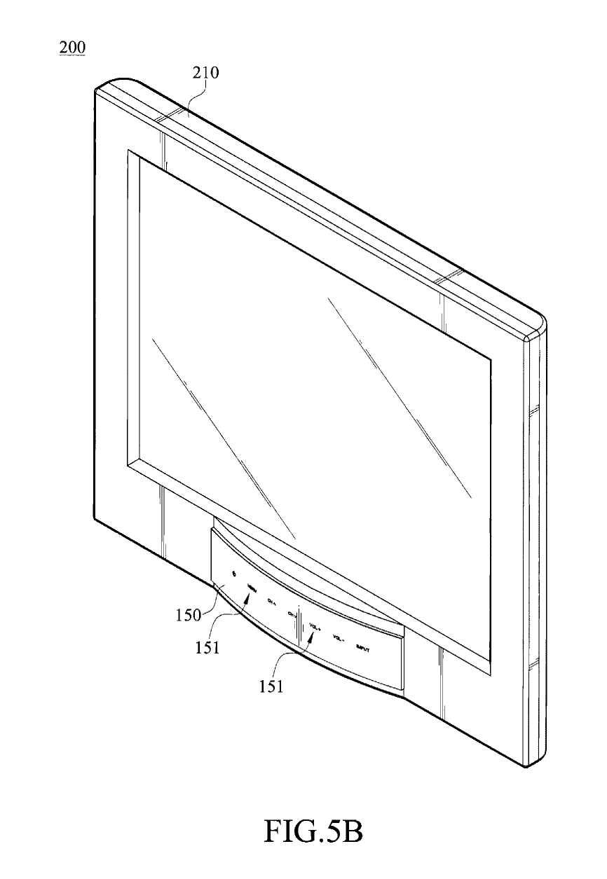

FIGS. 5A and 5B are an exploded view and a schematic three-dimensional view of a display device having the touch control device according to the first embodiment of the present invention disposed therein, so reference is made to FIGS. 5A and 5B together with FIG. 1A. As the most preferred embodiment of the present invention, a display device 200 of the present invention is an LCD, but the present invention is not limited thereto.

The display device 200 according to the first embodiment of the present invention has a frame body 210. A main board 220 and related electronic components (not shown) for activating the display device 200 are disposed in the frame body 210, and the touch control device 100 is disposed in the frame body 210. A front surface of the frame body 210 of the first embodiment has a curve shape, a panel 150 is disposed on the front surface of the frame body 210, and the light guiding sheet 140 of the touch control device 100 is closely attached to the panel 150 by the non-electrically-conductive adhesive. Further, the panel 150 has a plurality of display patterns 151, for example, a power supply icon, a channel switching icon, and a volume adjusting icon, each display pattern 151 is respectively corresponding to each trigger region 131 of the second circuit board 130, and the light emitted by the light emitting element 121 is uniformly scatted by the light guiding sheet 140, such that the display patterns of the panel 150 are clearly displayed, thereby allowing the user to correctly recognize functions represented by the display patterns 151, and thus correctly execute manipulation instructions.

Two opposite side edges of the panel 150 respectively have a buckling element 152, for example, a buckle piece, and each buckling element 152 respectively has a hook portion. When the touch control device 100 is disposed in the frame body 210, the hook portions of the buckling elements 150 are respectively hooked to the bracket 110, such that the touch control device 100 is stably disposed in the frame body 210 of the display device 200 without dislocation or even falling off. The buckling element 152 of this embodiment is in the form of a buckle piece integrally extending from the two side edges of the panel 150, and is hooked to the bracket 110 to form a fixed connection. However, persons skilled in the art may also adopt various types of fixing elements, for example, screws, pins, and bolts, as long as a holding relationship between the panel 150 and the bracket 110 is provided, and the present invention is not limited to this embodiment.

As shown in FIGS. 1A, 5A, and 5B, the main board 220 has a second electrical connector 221 electrically connected to the other electrical connection port 124 of the first circuit board 120, and when a finger of the user presses the panel 150, an electrical signal generated by the corresponding trigger region 131 of the second circuit board 130 due to the pressing action is successfully transmitted to the main board 220 through the first circuit board 120, such that the display device 200 executes a preset function corresponding to the triggered trigger region 131.

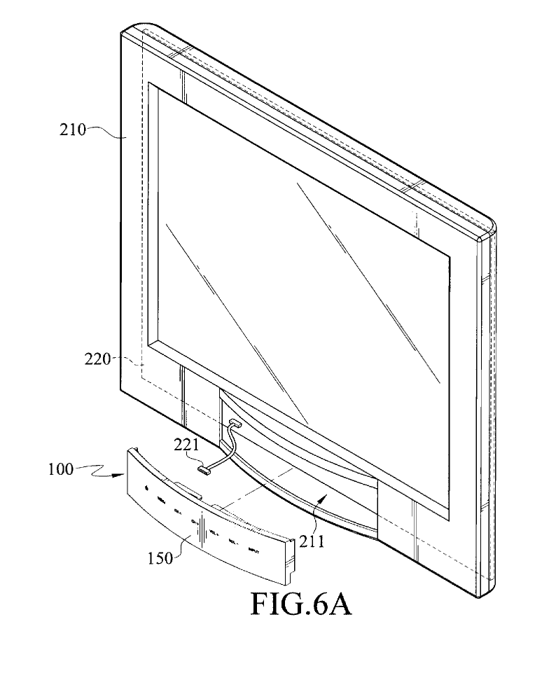

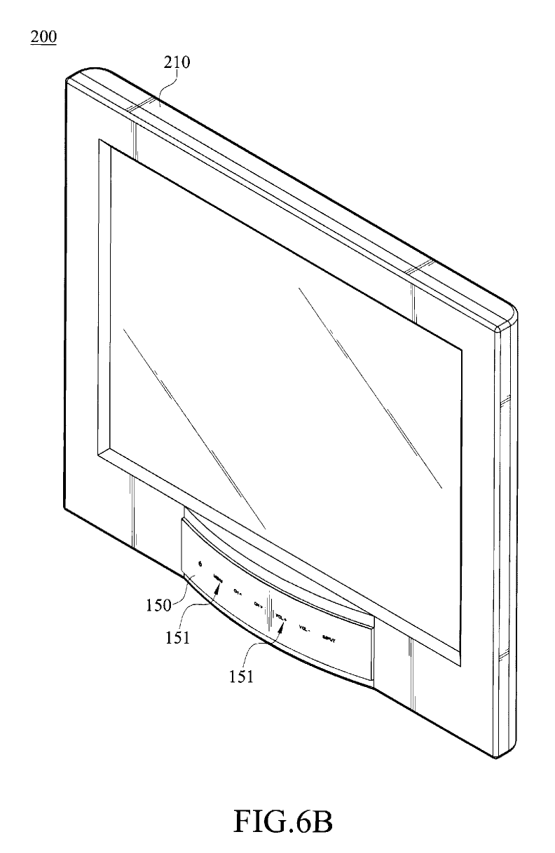

FIGS. 6A and 6B are an exploded view and a schematic three-dimensional view of a display device having the touch control device according to the second embodiment of the present invention disposed therein, so reference is made to FIGS. 6A and 6B together with FIG. 3A. As the most preferred embodiment of the present invention, a display device 200 of the present invention is a display system, but the present invention is not limited thereto.

The display device 200 according to the second embodiment of the present invention has a frame body 210. A main board 220 and related electronic components (not shown) for activating the display device 200 are disposed in the frame body 210. A front surface of the frame body 210 has a curve shape, and an accommodating opening 211 having a size matching the touch control device 100 is opened on the front surface of the frame body 210, such that the touch control device 100 is disposed in the frame body 210 through the accommodating opening 211, and the panel 150 of the touch control device 100 is exposed out of the frame body 210.

As shown in FIGS. 3A, 6A, and 6B, the main board 220 has a second electrical connector 221 electrically connected to the other electrical connection port 124 of the first circuit board 120, and when a finger of the user presses the panel 150, an electrical signal generated by the corresponding trigger region 131 of the second circuit board 130 due to the pressing action is successfully transmitted to the main board 220 through the first circuit board 120, such that the display device 200 executes a preset function corresponding to the triggered trigger region 131.

In the display device and the touch control device thereof according to the present invention, the second circuit board is erected on the first circuit board, so as to form a three-dimensional layout structure. Moreover, in the present invention, the trigger regions are electrically disposed on the flexible second circuit board, and the light emitting elements and other electronic components are electrically disposed on the rigid first circuit board, such that the second circuit board may be bent to various non-planar geometrical shapes without affecting the layout design and trigger sensitivity of the trigger regions.

Therefore, the touch control device of the present invention is applicable to various display devices having a curve-shaped appearance, and can greatly simplify the manufacturing process while improving the process yield, thereby meeting the requirements for mass production. Further, the touch control device of the present invention also has a lightweight and thin structure and good trigger sensitivity.

What is claimed is:

1. A touch control device, comprising:
a bracket;
a first circuit board, disposed on the bracket, and having at least one light emitting element;
a second circuit board, being a flexible printed circuit (FPC), electrically connected to the first circuit board, and having at least one trigger region opposite to the light emitting element; and
a light guiding sheet, attached to the second circuit board, for guiding light emitted by the light emitting element.

2. The touch control device according to claim 1, further comprising a panel, disposed on the bracket and attached to the light guiding sheet, having at least one display pattern, and displaying the display pattern using the light.

3. The touch control device according to claim 2, wherein two opposite side edges of the panel further respectively have a buckling element, for being hooked to the bracket.

4. The touch control device according to claim 3, wherein the buckling element is a buckle piece.

5. The touch control device according to claim 1, wherein the bracket has at least one fixing post, one end of the fixing post has a combination hole, the first circuit board has at least one through hole, and at least one combination member respectively passes through the through hole and is disposed in the combination hole, such that the first circuit board is fixed on the bracket.

6. The touch control device according to claim 1, wherein the bracket has at least one positioning post, the first circuit board has at least one positioning hole, and the positioning post is inserted in the positioning hole, such that the first circuit board is retained on the bracket.

7. The touch control device according to claim 1, wherein the first circuit board has two electrical connection ports, the second circuit board has a first electrical connector electrically connected to one of the electrical connection ports, and the other electrical connection port is electrically connected to a second electrical connector.

8. The touch control device according to claim 1, wherein the bracket further has at least one positioning rib protruding there-from, and the light guiding sheet presses against the positioning ribs, such that the trigger region of the second circuit board is aligned with the light emitting element.

9. The touch control device according to claim 1, wherein the light emitting element is a light emitting diode (LED).

10. A display device, comprising:
a frame body; and
a touch control device, disposed on the frame body, and comprising:
a bracket;
a first circuit board, disposed on the bracket, and having at least one light emitting element;
a second circuit board, being a flexible printed circuit (FPC), electrically connected to the first circuit board, and having at least one trigger region opposite to the light emitting element; and
a light guiding sheet, attached to the second circuit board, for guiding light emitted by the light emitting element.

11. The display device according to claim 10, wherein the frame body further comprises a panel, attached to the light guiding sheet, having at least one display pattern, and displaying the display pattern using the light.

12. The display device according to claim 11, wherein two opposite side edges of the panel further respectively have a buckling element, for being hooked to the bracket.

13. The display device according to claim 12, wherein the buckling element is a buckle piece.

14. The display device according to claim 10, wherein the bracket has at least one fixing post, one end of the fixing post has a combination hole, the first circuit board has at least one through hole, and at least one combination member respectively passes through the through hole and is disposed in the combination hole, such that the first circuit board is fixed on the bracket.

15. The display device according to claim 10, wherein the bracket has at least one positioning post, the first circuit board has at least one positioning hole, and the positioning post is inserted in the positioning hole, such that the first circuit board is retained on the bracket.

16. The display device according to claim 10, wherein the first circuit board has two electrical connection ports, the second circuit board has a first electrical connector electrically connected to one of the electrical connection ports, the frame body further has a main board, and the main board has a second electrical connector electrically connected to the other electrical connection port.

17. The display device according to claim 10, wherein the bracket further has at least one positioning rib protruding there-from, and the light guiding sheet presses against the positioning ribs, such that the trigger region of the second circuit board is aligned with the light emitting element.

18. The display device according to claim 10, wherein the light emitting element is a light emitting diode (LED).
